(19) United States
(12) Patent Application Publication
(10) Pub. No.: US 2004/0022517 A1
(43) Pub. Date: Feb. 5, 2004

(54) Information recording method and apparatus

(75) Inventor: Ryuichi Shiraishi, Kumagaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/457,648

(22) Filed: Jun. 10, 2003

(30) Foreign Application Priority Data
Jul. 31, 2002 (JP) 2002-223930

(51) Int. Cl. H04N 5/781

(52) U.S. Cl. 386/46; 386/125

(57) ABSTRACT

An information recording apparatus according to an embodiment of the present invention records an arbitrary picture contained in a plurality of pieces of picture information based on the DVD-RTR standard as a jacket picture of the DVD-Video standard.

### CROSS-REFERENCE TO RELATED APPLICATIONS

This application is based upon and claims the benefit of priority from the prior Japanese Patent Application No. 2002-223930, filed Jul. 31, 2002, the entire contents of which are incorporated herein by reference.

### BACKGROUND OF THE INVENTION

1. Field of the Invention

The present invention relates to an information recording method and apparatus for recording information on an information recording medium such as a DVD (Digital Versatile Disk).

2. Description of the Related Art

A recording/playback apparatus of the DVD-RTR (Real Time Recording) standard can record a representative picture in each of VMGI_MAT, PL_SRP, and PGI in the disk and also display the indices of representative pictures recorded in the disk in terms of its standard.

On the other hand, the DVD-Video standard includes a jacket picture which can arbitrarily be recorded by a disk producer.

The representative picture defined by the DVD-RTR standard and the jacket picture defined by the DVD-Video standard are completely different and have no relevance to each other.

Recently, an apparatus capable of converting picture data from the DVD-RTR standard into the DVD-Video standard and recording the picture data on a recording medium such as a DVD-R is commercially available. When this apparatus is used, to permanently store picture data recorded in the DVD-RTR standard, the picture data can be converted from the DVD-RTR standard into the DVD-Video standard and recorded on a recording medium such as a DVD-R. In addition, picture data in the DVD-RTR standard can be converted into the DVD-Video standard, recorded on a recording medium such as a DVD-R, and distributed to a user who does not have a DVD-RTR recording/playback apparatus but only has a DVD-Video playback apparatus.

However, when picture data is converted from the DVD-RTR standard into the DVD-Video standard and recorded, representative picture data defined in the DVD-RTR standard is not recorded because the DVD-Video standard has no concept of representative picture data.

### BRIEF SUMMARY OF THE INVENTION

An information recording method according to an aspect of the present invention comprises steps of acquiring information based on a DVD-RTR standard (a first standard), and recording, as a jacket picture of a DVD-Video standard (a second standard), predetermined picture information of a plurality of pieces of picture information contained in the acquired information.

An information recording apparatus according to another aspect of the present invention comprises acquisition unit for acquiring information based on a DVD-RTR standard, and recording unit for recording, as a jacket picture of a DVD-Video standard, predetermined picture information of a plurality of pieces of picture information contained in the information acquired by the acquisition unit.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram for explaining the overall arrangement of a digital recording/playback apparatus (DVD video recorder) according to an embodiment of the present invention;

FIG. 2 is a view showing the schematic data structure of DVD-RTR standard;

FIG. 3 is a view showing a concept in which when the DVD-RTR standard is converted into the DVD-Video standard, an arbitrary picture (e.g., a representative picture) based on the DVD-RTR standard is recorded as a jacket picture based on the DVD-Video standard;

FIG. 4 is a view partially showing the directory structure of the DVD-RTR standard;

FIG. 5 is a view partially showing the directory structure of the DVD-Video standard;

FIG. 6 is a view showing information about three sizes of jacket picture; and

FIG. 7 is a flow chart showing jacket picture generation processing.

### DETAILED DESCRIPTION OF THE INVENTION

The embodiment will be described below with reference to the accompanying drawings.

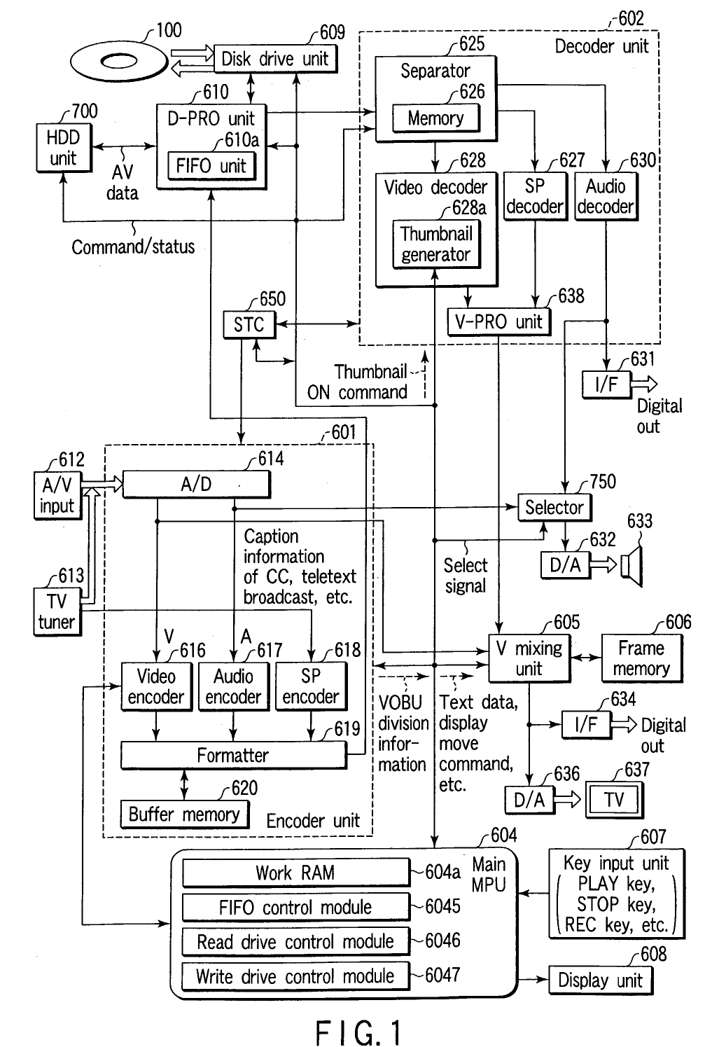

FIG. 1 is a block diagram for explaining the overall arrangement of a digital recording/playback apparatus (DVD video recorder) according to an embodiment of the present invention. This apparatus executes real-time video recording based on the DVD-RTR standard on a recordable optical disk (e.g., a DVD-RAM) 100 or hard disk. This apparatus also converts picture data based on the DVD-RTR standard into picture data in the DVD-Video standard and record the converted data in the recordable optical disk (e.g., a DVD-RAM) 100 or hard disk. This apparatus further has a function of playing back a read-only optical disk (DVD-ROM disk or recorded DVD-R disk).

The apparatus shown in FIG. 1 is constructed by an encoder unit 601, decoder unit 602, main MPU 604, V (Video) mixing unit 605, frame memory 606, key input unit 607, display unit 608, disk drive unit 609, D-PRO (data processor) unit 610, A/V input 612, TV tuner (BS/ground wave analog tuner) 613, audio digital I/F 631, audio digital D/A unit 632, loudspeaker 633 (an audio amplifier for driving the loudspeaker 633 is not illustrated), video digital I/D 634, TV D/A unit 636, external monitor TV 637, STC (system time counter) 650, HDD unit (an HDD recorder unit having a capacity of about 20 to 100 GB and/or a large-capacity IC memory) 700, audio signal selector 750, and the like.

The D-PRO unit 610 has an internal or external FIFO unit (FIFO buffer) 610a of first-in first-out type. The FIFO buffer that constitutes the FIFO unit 610a includes a recording-side FIFO and playback-side FIFO. The input/output control and remaining capacity monitor for the recording- and playback-side FIFOs are done by a control program called a FIFO control module 6045 written in the program ROM in the main MPU 604.

Read control from the disk drive unit 609 (or HDD unit 700) is done by a control program called a read drive control module 6046 written in the program ROM in the main MPU 604. Write control to the disk drive unit 609 (or HDD unit 700) is done by a control program called a write drive control module 6047 written in the program ROM in the main MPU 604.

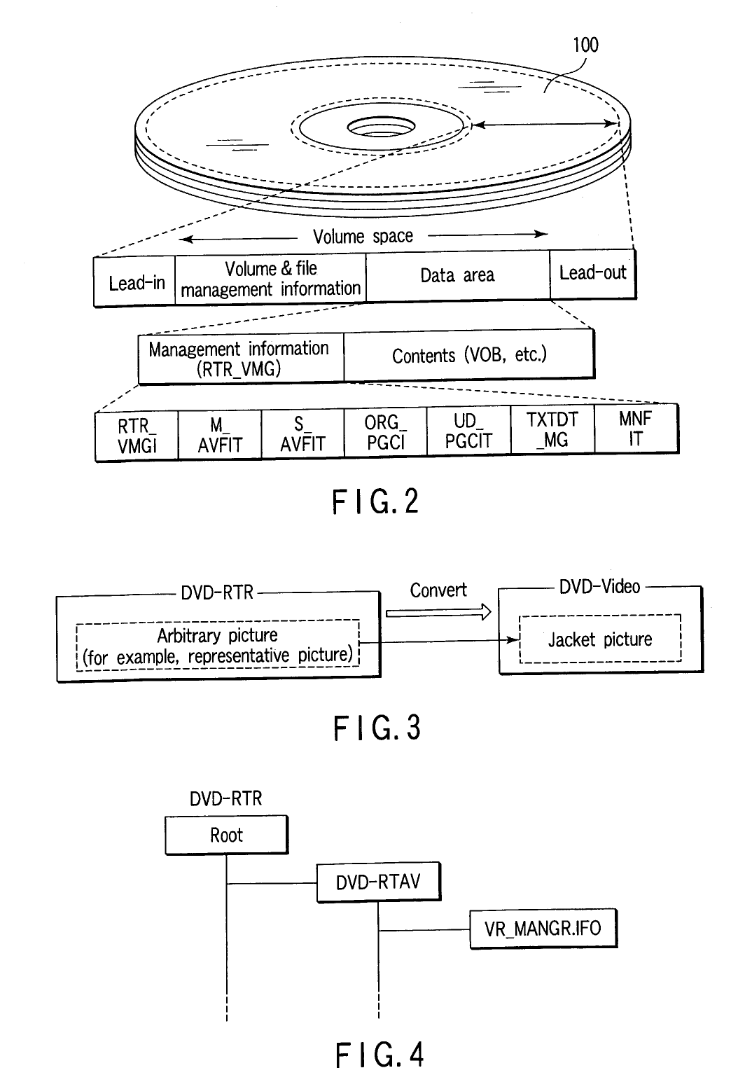

The main MPU 604 incorporates the ROM unit which includes the above control programs (firmware) and other control parameters, and a work RAM 604a to be used in executing each program. The work RAM 604a includes a memory area called a VMG holding unit (not shown) which temporarily stores management information (RTR_VMG) shown in FIG. 2.

The encoder unit 601 is constituted by an A/D unit 614, video encoder 616, audio encoder 617 including a dual/mono header setting unit 617a, SP (sub-picture) encoder 618, formatter 619, and buffer memory 620. The decoder unit 602 is constituted by a separator 625 incorporating a memory 626, video decoder 628 incorporating a thumbnail generator 628a, SP (sub-picture) decoder 627, audio decoder 630, and V-PRO (video processor) unit 638.

Recording (recording of AV information) is done by the disk drive unit 609 using the disk 100 such as a DVD-RAM, DVD-R, or DVD-RW through the encoder unit 601. The disk drive unit 609 can play back not only information from a disk such as DVD-RAM, DVD-R, or DVD-RW but also information from a disk such as a DVD video or DVD-ROM. That is, playback of a disk of DVD family is performed by the disk drive unit 609 and decoder unit 602 through the D-PRO unit 610. The function for DVD video playback can basically be the same as that of a commercially available DVD video player.

The actual flow of a video signal in the apparatus shown in FIG. 1 is as follows. First, an AV signal obtained from, e.g., the TV tuner 613 is input to the A/D unit 614 and converted into a digital signal. The converted digital signal is input to the video encoder 616. The digital audio signal is input to the audio encoder 617. When character data such as character broadcast is output from the TV tuner 613 in receiving/recording ground wave analog broadcast, the data is input to the SP (sub-picture) encoder 618. In receiving/recording ground wave analog broadcast, the signal is temporarily converted into a digital signal by the A/D unit 614. The video signal input to the video (main picture) encoder 616 is compressed by MPEG. The audio signal input to the audio encoder 617 is compressed by, e.g., MPEG audio. The character data input to the SP encoder 618 is compressed by run length.

In the encoders 616 to 618, data packets each having a size of, e.g., 2,048 bytes are formed. The signals (video data, audio data, and sub-picture data) in the form of packet are input to the formatter 619. The formatter 619 forms packs of the received packet data, multiplexes the packs, and sends the multiplexed signal (video pack, audio pack, and sub-picture pack) to the D-PRO unit 610.

The formatter 619 can output data (picture information) based on the DVD-RTR standard on the basis of encoded data supplied from the video encoders 616 to 618. The formatter 619 can also output data (picture information) based on the DVD-Video standard on the basis of encoded data supplied from the video encoders 616 to 618. More specifically, it is possible to read out picture information based on the DVD-RTR standard, which is recorded on the disk 100 by the disk drive unit 609, convert the picture information into picture information based on the DVD-Video standard through the formatter 619, and cause the disk drive unit 609 to record the picture information based on the DVD-Video standard on another disk 100. Various kinds of control for conversion from the DVD-RTR standard to the DVD-Video standard are done by the main MPU 604.

The D-PRO unit 610 forms an ECC block for every 16 packs/16 sectors in a current DVD video (or 32 packs/32 sectors or more in a next-generation DVD video) and adds error correcting data. The thus obtained data stream is recorded on the optical disk (DVD-RAM, DVD-RW, or DVD-R) 100 or in the HDD unit 700 by the disk drive unit 609. If the disk drive unit 609 is busy during seek or track jump, record data is temporarily stored in the HDD unit 700 (and/or a semiconductor memory (not shown)) serving as a temporary storage unit such that the processing can wait until the disk drive unit 609 becomes ready for recording.

In addition, the formatter 619 generates division information during recording (by, e.g., GOP start interrupt) and periodically sends the generated division information to the main MPU 604. The division information includes the number of packs of VOBUs (Video OBject Units) as a data access unit, the end address of an I picture from the start of the VOBU, and the VOBU playback time. Each VOBU can include the video pack, audio pack and/or sub-picture pack. The disk drive unit 609 can access information recorded on the disk 100 for each VOBU. In the DVD-RTR standard, one video file is recorded on one disk.

FIG. 2 is a view showing the schematic data structure of the DVD-RTR standard.

An example in which volume space information is recorded in the information recording area of the DVD-RAM disk 100 shown in FIG. 2 will be described here (the data structure of record information in the HDD unit 700 also has the same structure).

The volume space of the disk 100 includes a recording area for volume file/file management information and a data area where user data (AV information and the like) is to be recorded. In this data area, management information RTR_VMG and the contents (a video object VOB of AV information, and the like) of user data can be recorded.

Playback information of contents is defined in a file VR_MANGR.IFO. The VR_MANGR.IFO is recorded as the management information RTR_VMG.

The management information RTR_VMG contains RTR video manager information RTR_VMGI, movie AV file information table M_AVFIT, still picture AV file information table S_AVFIT, original program chain information ORG_PGCI, user-defined program chain information table UD_PGCIT, text data manager TXTDT_MG, and manufacturer information MNFIT.

The RTR video manager information RTR_VMGI defines the basic information of the RTR disk. The movie AV file information table M_AVFIT defines the information of a picture file VR_MOVIE.VRO. The still picture AV file information table S_AVFIT defines information about a still picture file VR_STILL.VRO. The original program chain information ORG_PGCI defines information about an original PRC. The user-defined program chain information table UD_PGCIT defines information of at least one program chain PGC defined by the user. The text data manager TXTDT_MG defines text data about a recorded picture. Of these pieces of information, pieces of program information contained in each of the program chains PGC defined by the RTR video manager information RTR_VMGI, original program chain information ORG_PGCI, and user-defined program chain information table UD_PGCIT contain representative picture information.

Program chain information PGCI is a data structure representing the whole playback of the program chain PGC, and PGC indicates a series of programs PG (program set). PG is a logic unit of recorded contents and can be recognized or defined by the user. The PG in the program set is formed from one or more original cells (the playback unit of the first recorded contents). PG is defined only in the original program chain information ORG_PGCI. In other words, the original program chain information ORG_PGCI is information that describes the cell playback order of the first recorded contents. The user-defined program chain information table UD_PGCIT is a table that describes one or more pieces of program chain information PGCI edited by the user after recording.

On the other hand, the DVD-Video standard has a jacket picture that defines that one still picture is added to one disk. The main object of the jacket picture is to provide a graphical user interface which can be used to select a specific disk from a number of disks. For example, a multi-disk player can create a “disk menu” by laying out a number of jacket pictures on the screen.

The DVD-Video standard has no concept to record the above-described representative picture information. However, representative picture information can be prepared by combining with the jacket picture standard of the DVD-Video standard.

As shown in FIG. 3, when the formatter 619 is to convert picture information of the DVD-RTR standard into the DVD-Video standard, a representative picture defined by the user in the DVD-RTR standard, a received picture defined by the user, or an arbitrary picture on the disk can be converted into a jacket picture.

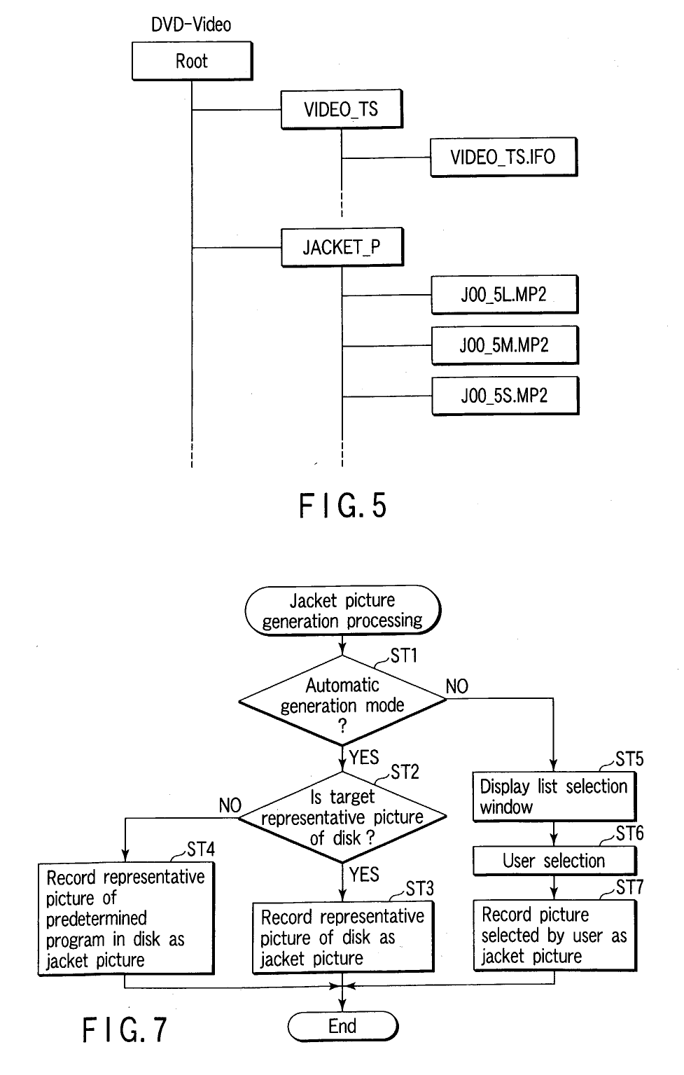

The directory structure of the DVD-RTR standard and that of the DVD-Video standard will be briefly described now with reference to FIGS. 4 and 5. FIG. 4 is a view partially showing the directory structure of the DVD-RTR standard. FIG. 5 is a view partially showing the directory structure of the DVD-Video standard.

As shown in FIG. 4, in the directory structure of the DVD-RTR standard, VR_MANGR.IFO branches from DVD_RTAV. VR_MANGR.IFO stores the representative picture of a disk and the representative picture of each program in the disk.

As shown in FIG. 5 in the directory structure of the DVD-Video standard, VIDEO_TS.IFO branches from VIDEO_TS, and J00_{—}5L.MP2, J00_{—}5M.MP2, and J00_{—}5S.MP2 branch from JACKET_P. J00_{—}5L.MP2, J00_{—}5M.MP2, and J00_{—}5S.MP2 store identical jacket pictures. J00_{—}5L.MP2 stores a jacket picture of L size, J00_{—}5M.MP2 stores a jacket picture of M size, and J00_{—}5S.MP2 stores a jacket picture of S size.

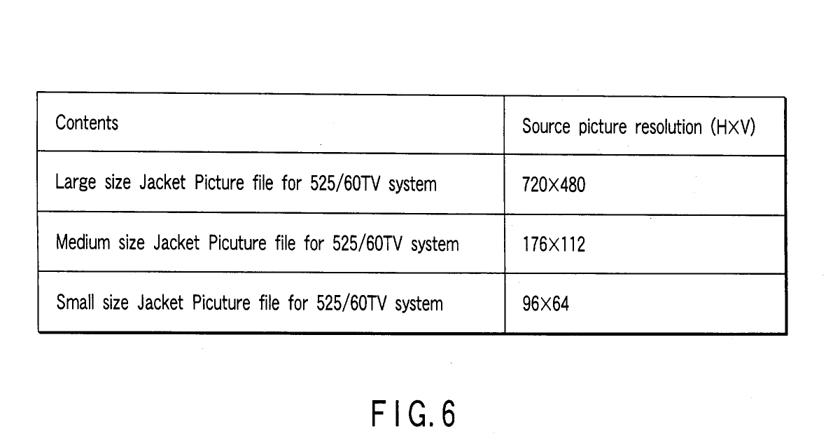

FIG. 6 is a view showing information about three sizes of jacket picture. As shown in FIG. 6, J00_{—}5L.MP2 stores a jacket picture of 720×480 size. J00_{—}5M.MP2 stores a jacket picture of 176×112 size. J00_{—}5S.MP2 stores a jacket picture of 96×64 size.

Only a case wherein a jacket picture corresponding to NTSC (525/60 TV system) is stored has been described above. However, a jacket picture corresponding to PAL (625/50 TV system) can also be stored. In this case, a jacket picture corresponding to PAL (625/50 TV system) is also stored in three sizes, like the jacket picture corresponding to NTSC.

To play back a disk recorded on the basis of the DVD-RTR standard, a file system recorded on the UDF standard is loaded, and the recording positions of the VR_MANGR.IFO defined in the DVD-RTR standard and the picture data VR_MOVIE.VRO and VR_STILL.VRO are detected.

Next, the data of the VR_MANGR.IFO is read to prepare for picture/audio playback. Next, ORG_PGCI or UD_PGCI in UD_PGCIT is searched for as a title number designated by the user. At this time, if a representative picture designated by the user is defined, a picture corresponding to this data is searched for.

After that, the playback position of a VRO file to be played back is searched for, and picture data is supplied to the MPEG2 decoder (decoder unit 602).

The MPEG2 decoder (decoder unit 602) decodes picture and audio data. Decoded data is displayed as a picture on an external display connected to the apparatus or output as sound.

The decoded data is stored in a display buffer in the decoder. This data is encoded into an I-picture based on the MPEG2 standard by the recording encoder (formatter 619).

The generated I-picture is recorded in the directory “JACKET_P” with a file name defined in the jacket picture standard. A jacket picture generated in the above-described way and data based on the DVD-Video standard are written in a recording medium such as a DVD-R. Accordingly, the jacket picture can be played back by an existing DVD video player having a jacket picture playback function.

More specifically, when a representative picture defined on the basis of the DVD-RTR standard is recorded on a recording medium as a jacket picture based on the DVD-Video standard, the picture data defined on the basis of the DVD-RTR standard can be converted into picture data defined on the basis of the DVD-Video standard without losing the representative picture defined on the basis of the DVD-RTR standard.

The present invention is not limited to a case wherein picture information defined on the basis of the DVD-RTR standard is recorded on a recording medium as a jacket picture based on the DVD-Video standard. The present invention can also be applied to a case wherein, e.g., data on a PC is to be recorded on a recording medium as a jacket picture based on the DVD-Video standard using a JPEG viewer. The present invention can also be applied to a case wherein picture information contained in TV broadcast by a ground wave or satellite wave is to be recorded on a recording medium as a jacket picture based on the DVD-Video standard.

Jacket picture generation processing will be described next with reference to FIG. 7. Jacket picture generation can roughly be classified into an automatic generation mode and a user choice generation mode. The mode is set in advance by the recording/playback apparatus shown in FIG. 1.

When the automatic generation mode is set (ST1), the processing can further be classified into processing of recording the representative picture of a disk as a jacket picture and processing of recording the representative picture of a predetermined program in a disk as a jacket picture. Both modes are preset in the recording/playback apparatus.

When the representative picture of a disk is to be recorded as a jacket picture (YES in ST2), the representative picture is read out from the disk, and the readout representative picture is recorded as a jacket picture (ST3). That is, the representative picture is read out from VR_MANGR.IFO shown in FIG. 4. The readout representative picture is stored in J★★_{—}5L.MP2 (for L size), J★★_{—}5M.MP2 (for M size), and J★★_{—}5S.MP2 (for S size) of JACKET_P shown in FIG. 5 and recorded as a jacket picture.

When the representative picture of a predetermined program in a disk is to be recorded as a jacket picture (NO in ST2), the representative picture of the predetermined program of the disk is read out, and the readout representative picture is recorded as a jacket picture (ST4). That is, the representative picture read out from a disk of DVD-RTR standard is stored in J★★_{—}5L.MP2 (for L size), J★★_{—}5M.MP2 (for M size), and J★★_{—}5S.MP2 (for S size) of JACKET_P shown in FIG. 5 and recorded as a jacket picture. The predetermined program may be either a program (e.g., program chain information) arbitrarily determined by the recording/playback apparatus or the first one of a plurality of programs clipped by the user.

On the other hand, the user choice generation mode is selected (NO in ST1), a plurality of images (e.g., thumbnails) defined on the basis of the DVD-RTR standard are read out and displayed as a list on the selection window (ST5). When the user selects a desired picture from the selection window (ST6), the selected picture is recorded as a jacket picture (ST7). That is, the representative picture read out from a disk of DVD-RTR standard is stored in J★★_{—}5L.MP2 (for L size), J★★_{—}5M.MP2 (for M size), and J★★_{—}5S.MP2 (for S size) of JACKET_P shown in FIG. 5 and recorded as a jacket picture.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information recording method comprising:
acquiring information based on a first standard; and
recording, as a jacket picture of a second standard, predetermined picture information of a plurality of pieces of picture information contained in the acquired information.

2. A method according to claim 1, wherein the first standard based on a DVD-RTR standard and the second standard based on a DVD-Video standard.

3. A method according to claim 1, wherein picture information designated by program chain information based on the first standard is recorded as the jacket picture of the second standard.

4. A method according to claim 1, wherein thumbnail information based on the first standard is recorded as the jacket picture of the second standard.

5. A method according to claim 1, wherein picture information selected by a user from the plurality of pieces of picture information is recorded as the jacket picture of the second standard.

6. A method according to claim 1, wherein picture information defined as a target of the jacket picture in advance from the plurality of pieces of picture information is recorded as the jacket picture of the second standard.

7. A method according to claim 6, wherein the picture information defined as the target of the jacket picture in advance is a representative picture of a disk.

8. A method according to claim 6, wherein the picture information defined as the target of the jacket picture in advance is a representative picture of a program stored in a disk.

9. An information recording apparatus comprising:
acquisition unit for acquiring information based on a first standard; and
recording unit for recording, as a jacket picture of a second standard, predetermined picture information of a plurality of pieces of picture information contained in the information acquired by the acquisition unit.

10. An apparatus according to claim 9, wherein the first standard based on a DVD-RTR standard and the second standard based on a DVD-Video standard.

11. An apparatus according to claim 9, wherein the recording unit records, as the jacket picture of the second standard, picture information designated by program chain information based on the first standard.

12. An apparatus according to claim 9, wherein the recording unit records thumbnail information based on the first standard as the jacket picture of the second standard.

13. An apparatus according to claim 9, wherein the recording unit records, as the jacket picture of the second standard, picture information selected by a user from the plurality of pieces of picture information.

14. An apparatus according to claim 9, wherein the recording unit records, as the jacket picture of the second standard, picture information defined as a target of the jacket picture in advance from the plurality of pieces of picture information.

15. An apparatus according to claim 14, wherein the picture information defined as the target of the jacket picture in advance is a representative picture of a disk.

16. An apparatus according to claim 14, wherein the picture information defined as the target of the jacket picture in advance is a representative picture of a program stored in a disk.
